(19) United States
(12) Patent Application Publication
(10) Pub. No.: US 2024/0405474 A1
(43) Pub. Date: Dec. 5, 2024

(54) Connector, Connector Module and Connector Assembly

(71) Applicants: Tyco Electronics (Shanghai) Co., Ltd., Shanghai (CN); TE Connectivity Connectors (Suzhou) Co., Ltd., Suzhou (CN)

(72) Inventors: Yousheng (Colin) Chen, Suzhou (CN); Haijian Bian, Suzhou (CN); Xiang Li, Shenzhen (CN)

(73) Assignees: Tyco Electronics (Shanghai) Co., Ltd., Shanghai (CN); TE Connectivity Connectors (Suzhou) Co., Ltd., Suzhou (CN)

(21) Appl. No.: 18/678,396

(22) Filed: May 30, 2024

(30) Foreign Application Priority Data
Jun. 1, 2023 (CN) 202310641636.3

(51) Int. Cl. H01R 13/514; H01R 12/70; H01R 13/627

(52) U.S. Cl. CPC H01R 13/514; H01R 12/707; H01R 13/6273

(57) ABSTRACT

A connector includes a housing and at least one row of terminals arranged therein. The housing has at least one layer of inner chamber, with each layer of inner chamber including multiple vertical partition walls formed therein and multiple vertical partition plates formed on an outer side of a side wall of the housing. Each terminal includes a mating part accommodated in the inner chamber for mating with a mating terminal of a mating connector, and a connecting part extending from the side wall of the housing for electrically connecting to a circuit board. The mating parts of adjacent two terminals in each row of terminals are separated by the vertical partition wall, and the connecting parts of adjacent two terminals in each row of terminals are separated by the vertical partition plate.

### CROSS-REFERENCE TO RELATED APPLICATION

This application claims the benefit of Chinese Patent Application No. CN202310641636.3 filed on Jun. 1, 2023 in the State Intellectual Property Office of China, the whole disclosure of which is incorporated herein by reference.

### FIELD OF THE INVENTION

Embodiments of the present disclosure relate to a connector, a connector module comprising the connector, and a connector assembly comprising the connector or connector module.

### BACKGROUND

In the prior art, the application voltage of the high-voltage signal acquisition connector for the battery pack on new energy vehicles is 600V. However, the application voltage of the high-voltage signal acquisition connector for the next generation battery pack will be increased to 800-1000V. The existing high-voltage signal acquisition connectors cannot meet the relevant technical parameters necessitated by these increases. Accordingly, a new generation of high-voltage signal acquisition connectors capable of meeting 1000V is required.

### SUMMARY

According to an embodiment of the present disclosure, a connector includes a housing and at least one row of terminals arranged therein. The housing has at least one layer of inner chamber, with each layer of inner chamber including multiple vertical partition walls formed therein and multiple vertical partition plates formed on an outer side of a side wall of the housing. The at least one row of terminals is arranged in the at least one layer of inner chamber. Each terminal includes a mating part accommodated in the inner chamber for mating with a mating terminal of a mating connector, and a connecting part extending from the side wall of the housing for electrically connecting to a circuit board. The mating parts of adjacent two terminals in each row of terminals are separated by the vertical partition wall, and the connecting parts of adjacent two terminals in each row of terminals are separated by the vertical partition plate.

### BRIEF DESCRIPTION OF THE DRAWINGS

The invention will now be described by way of example with reference to the accompanying Figures, of which:

FIG. 1 shows an illustrative perspective view of a connector assembly according to an exemplary embodiment of the present invention;

FIG. 2 shows an illustrative exploded view of a connector assembly according to an exemplary embodiment of the present invention;

FIG. 3 shows a vertical sectional view of a connector assembly according to an exemplary embodiment of the present invention when viewed from the rear, wherein the connector and the mating connector have been mated together;

FIG. 4 shows a vertical sectional view of a connector assembly according to an exemplary embodiment of the present invention when viewed from the rear, wherein the connector and the mating connector have not yet been mated together;

FIG. 5 shows a vertical sectional view of a connector assembly according to an exemplary embodiment of the present invention when viewed from the front side, wherein the connector and the mating connector have not yet been mated together;

FIG. 6 shows a horizontal sectional view of a connector assembly according to an exemplary embodiment of the present invention, wherein the connector and the mating connector have been mated together;

FIG. 7 shows a horizontal sectional view of a connector assembly according to an exemplary embodiment of the present invention, wherein the connector and the mating connector have not yet been mated together;

FIG. 8 shows an illustrative perspective view of a mating connector according to an exemplary embodiment of the present invention when viewed from the bottom, wherein the terminal locking member has been assembled onto the mating housing;

FIG. 9 shows an illustrative perspective view of a mating connector according to an exemplary embodiment of the present invention when viewed from the bottom, wherein the terminal locking member has not yet been assembled onto the mating housing;

FIG. 10 shows an illustrative perspective view of a terminal locking member of a mating connector according to an exemplary embodiment of the present invention;

FIG. 11 shows an illustrative perspective view of a terminal locking member, terminal, and cable of a mating connector according to an exemplary embodiment of the present invention when viewed from the front side, wherein the terminal locking member has not yet leaned against the terminal;

FIG. 12 shows an illustrative perspective view of a terminal locking member, terminal, and cable of a mating connector according to an exemplary embodiment of the present invention when viewed from the rear, wherein the terminal locking member has not yet leaned against the terminal;

FIG. 13 shows an illustrative perspective view of a terminal locking member, terminal, and cable of a mating connector according to an exemplary embodiment of the present invention when viewed from the front side, wherein the terminal locking member has already leaned against the terminal;

FIG. 14 shows an illustrative perspective view of a connector assembly according to another exemplary embodiment of the present invention;

FIG. 15 shows an illustrative exploded view of a connector assembly according to another exemplary embodiment of the present invention;

FIG. 16 shows a cross-sectional schematic diagram of a connector assembly according to another exemplary embodiment of the present invention, wherein the connector and the mating connector have already been mated together; and

FIG. 17 shows a cross-sectional schematic diagram of a connector assembly according to another exemplary embodiment of the present invention, wherein the connector and the mating connector have not yet been mated together.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

A connector according to an embodiment of the present disclosure comprises a housing having at least one layer of inner chamber, and at least one row of terminals respectively arranged in the at least one layer of inner chamber. The terminal comprises a mating part accommodated in the inner chamber for mating with a mating terminal of a mating connector and a connecting part extending from a side wall of the housing for electrically connecting to a circuit board. The housing comprises multiple vertical partition walls formed in each layer of inner chamber and multiple vertical partition plates formed on the outer side of the side wall. The mating parts of adjacent two terminals in each row of terminals are separated by the vertical partition wall, and the connecting parts of adjacent two terminals in each row of terminals are separated by the vertical partition plate.

According to another embodiment of the present disclosure, a connector module includes a circuit board, and the above connector installed on the circuit board. The terminal of the connector is electrically connected to the circuit board. A connector assembly according to yet another embodiment of the present disclosure includes the above connector or the above connector module, and a mating connector inserted into the inner chamber of the housing of the connector to mate with the connector.

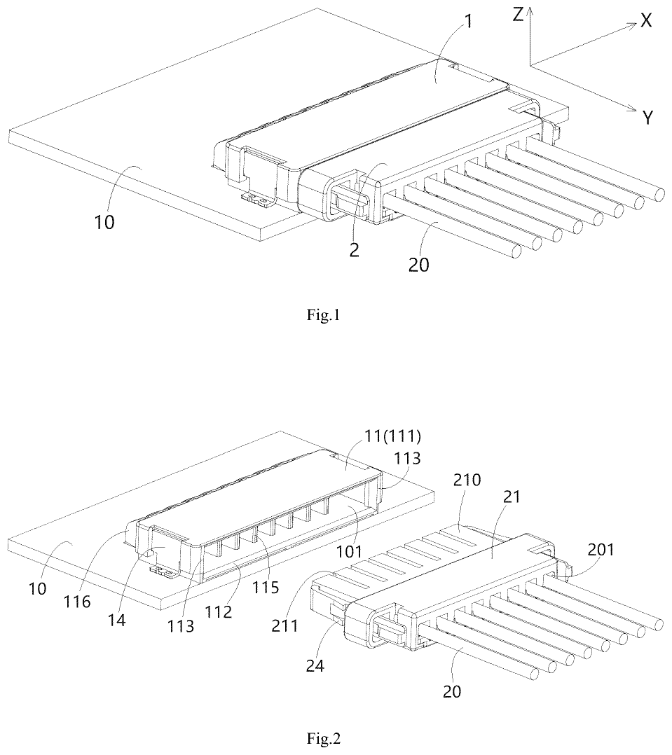

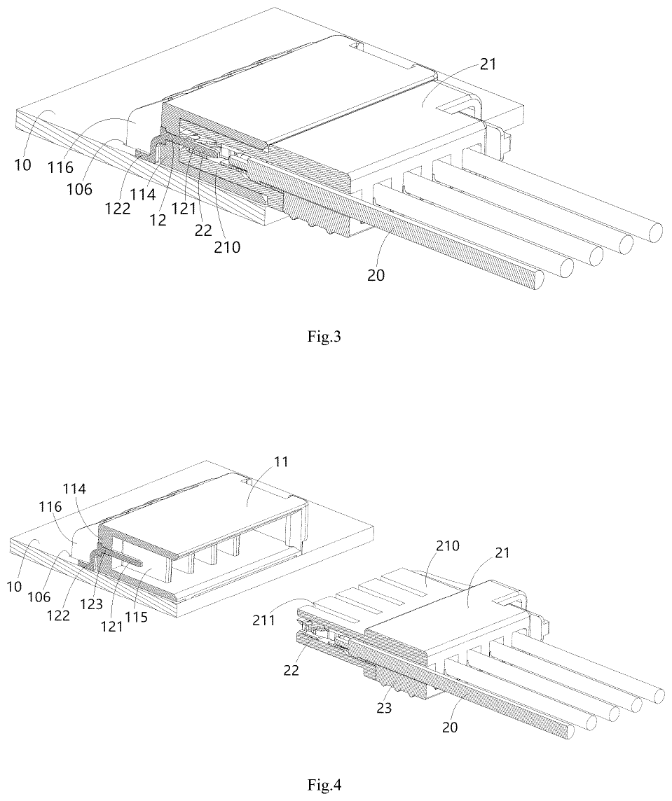

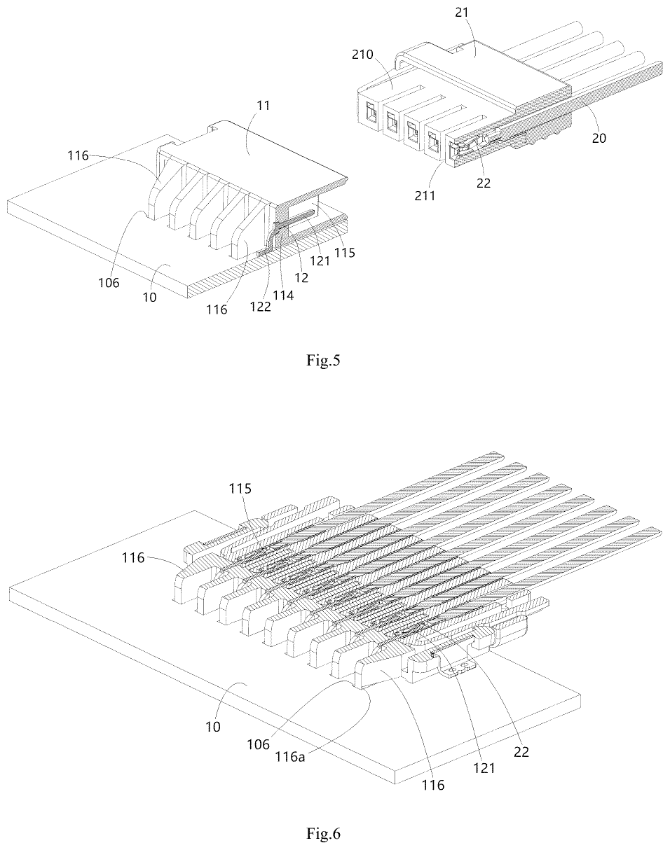

FIG. 1 shows an illustrative perspective view of a connector assembly according to an exemplary embodiment of the present invention. FIG. 2 shows an illustrative exploded view of a connector assembly according to an exemplary embodiment of the present invention. FIG. 3 shows a vertical sectional view of a connector assembly according to an exemplary embodiment of the present invention when viewed from the rear, wherein a connector 1 and a mating connector 2 have been mated together. FIG. 4 shows a vertical sectional view of a connector assembly according to an exemplary embodiment of the present invention when viewed from the rear, wherein the connector 1 and mating connector 2 have not yet been mated together.

As shown in FIGS. 1-4, in an exemplary embodiment of the present invention, the connector 1 includes a housing 11 and a row of terminals 12. The housing 11 has an inner chamber 101. A row of terminals 12 are arranged in the inner chamber 101 of the housing 11. Terminal 12 includes a mating part 121 accommodated in the inner chamber 101 for mating with a mating terminal 22 of a mating connector 2, and a connecting part 122 extending from the side wall 114 of the housing 11 for electrically connecting to the circuit board 10. The housing 11 includes multiple vertical partition walls 115 formed in each inner chamber 101 and multiple vertical partition plates 116 formed on the outer side of the side wall 114. The mating parts 121 of adjacent terminals 12 in each row of terminals 12 are separated by the vertical partition wall 115. The connecting parts 122 of adjacent terminals 12 in each row of terminals 12 are separated by the vertical partition plate 116.

Due to the vertical partition wall 115 and vertical partition plate 116 formed on the housing 11 of connector 1, which separates adjacent two terminals 12, the creepage distance between adjacent terminals 12 can be increased without increasing the pitch between adjacent terminals 12. This increased creepage distance enables the connector 1 to operate at high voltage above 1000V. For example, in the illustrated embodiment, the connector 1 is a high-voltage connector suitable for voltages above 1000V, and the pitch between adjacent terminals 12 in a row of terminals 12 is not greater than 3.5 mm.

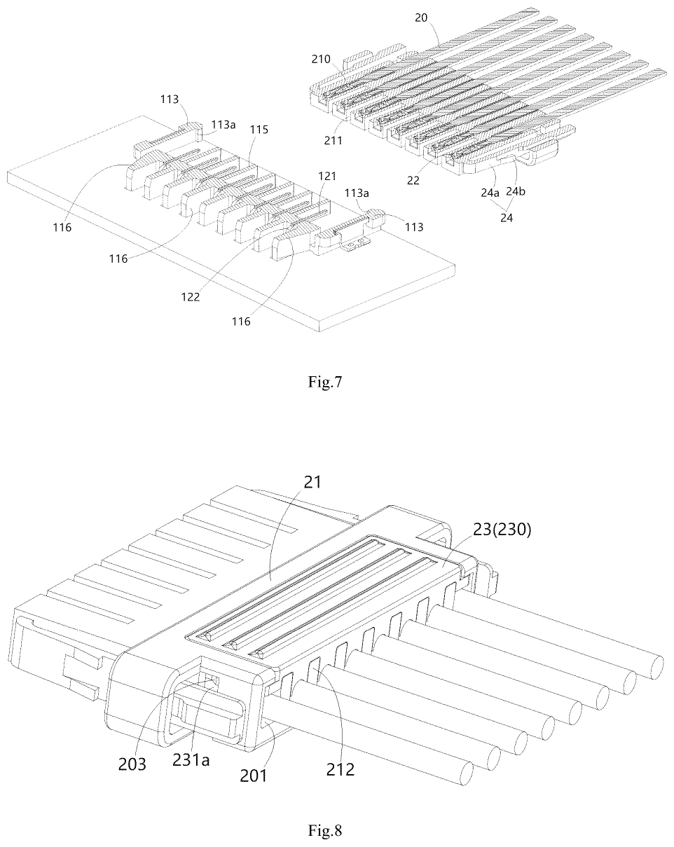

FIG. 5 shows a vertical sectional view of a connector assembly according to an exemplary embodiment of the present invention when viewed from the front side, wherein the connector 1 and the mating connector 2 have not yet been mated together. FIG. 6 shows a horizontal sectional view of a connector assembly according to an exemplary embodiment of the present invention, wherein the connector 1 and the mating connector 2 have been mated together. FIG. 7 shows a horizontal sectional view of a connector assembly according to an exemplary embodiment of the present invention, wherein the connector 1 and the mating connector 2 have not yet been mated together.

As shown in FIGS. 1 to 7, a leg 116a is formed at the bottom of the vertical partition plate 116, which is used for inserting into a slot 106 formed in the circuit board 10. The housing 11 comprises a top wall 111 and a bottom wall 112 opposite to each other in its height direction Z, two side walls 113 opposite to each other in its transverse direction X, and a rear opening and a front side wall 114 opposite to each other in its longitudinal direction Y. Multiple vertical partition walls 115 are arranged in a row along the transverse direction X, and multiple vertical partition plates 116 are arranged in a row along the transverse direction X. Multiple vertical partition plates 116 are connected to the outer side of the front side wall 114 of the housing 11, and the connecting part 122 of the terminal 12 extends from the front side wall 114 of the housing 11.

The connecting part 122 of any terminal 12 in each row of terminals 12 is located between adjacent vertical partition plates 116. The thickness of the two outermost vertical partition plates 116 in a row of vertical partition plates 116 is greater than that of the other vertical partition plates 116 to prevent damage to the thinner vertical partition plates 116 under external forces.

Locking protrusions 113a are respectively formed on the inner sides of the left and right side walls 113 of each layer of the inner chamber 101 of the housing 11. The locking protrusions 113a are used to engage with the mating housing 21 to lock the mating housing 21 inserted into the inner chamber 101 of the housing 11 in the inner chamber 101. The terminal 12 further comprises a fixing portion 123 located between the mating part 121 and the connecting part 122, which is fixed to the front side wall 114 of the housing 11. The connector further comprises a pair of welding legs 14, which are respectively installed on the left and right side walls 113 of the housing 11. The pair of welding legs 14 and the connecting part 122 of the terminal 12 are adapted to be soldered onto the circuit board 10 in a surface mount manner. The housing 11 has a single-layer of inner chamber 101, and a vertical partition wall 115 is connected between the top wall 111 and the bottom wall 112 of the housing 11.

Still referring to FIGS. 1-7, in another exemplary embodiment of the present invention, a connector module is also disclosed. The connector module includes a circuit board 10 and the connector 1. The connector 1 is installed on the circuit board 10, and the terminal 12 of the connector 1 is electrically connected to the circuit board 10. A row of slots 106 is formed in the circuit board 10, and the legs 116a of a row of vertical partition plates 116 of the housing 11 of connector 1 are respectively inserted into the row of slots 106.

In another exemplary embodiment, a connector assembly is also disclosed. The connector assembly mainly includes the aforementioned connector 1 or the aforementioned connector module, as well as the mating connector 2. The mating connector 2 is inserted into the inner chamber 101 of housing 11 of connector 1 to mate with the connector 1.

The mating connector 2 comprises a mating housing 21 and a row of mating terminals 22. The mating housing 21 is suitable for mating with the connector housing 11 and is formed with a row of terminal holes 201. A row of mating terminals 22 are respectively inserted into the row of terminal holes 201 of the mating housing 21. The mating housing 21 includes a front end portion 210 inserted into the inner chamber 101 of the housing 11, and the mating part 121 of the connector terminal 12 is mated with the mating terminal 22 inserted into the inner chamber 101.

A row of partition slots 211 is formed in the front end portion 210 of the mating housing 21, and the row of vertical partition walls 115 in the inner chamber 101 of the housing are respectively inserted into the row of partition slots 211 of the mating housing 21.

Elastic buckles 24 are respectively formed on the outer sides of the left and right sides of the front end portion 210 of the mating housing 21. The elastic buckles 24 is engage with the locking protrusion 113a in the inner chamber 101 of the housing 11 to lock the connector 1 and the mating connector 2 together. The elastic buckle 24 comprises a cantilever part 24a and a protrusion portion 24b. One end of the cantilever part 24a is connected to the mating housing 21. The protruding part 24b is formed on the cantilever part 24a. The protruding part 24b on the elastic buckle 24 is engaged with the locking protrusion 113a in the inner chamber 101 of the housing 11.

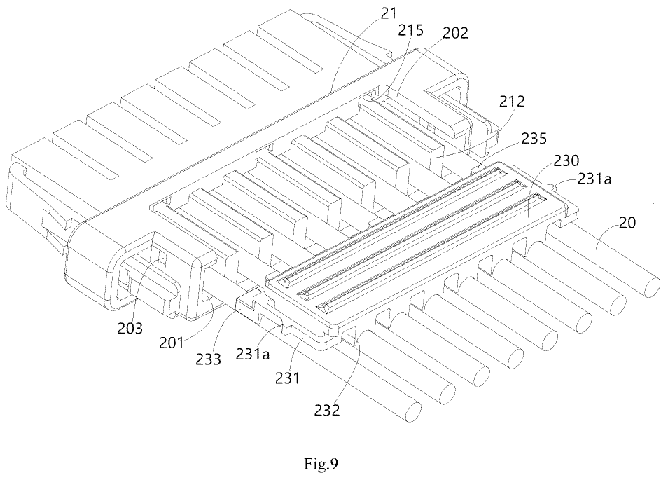

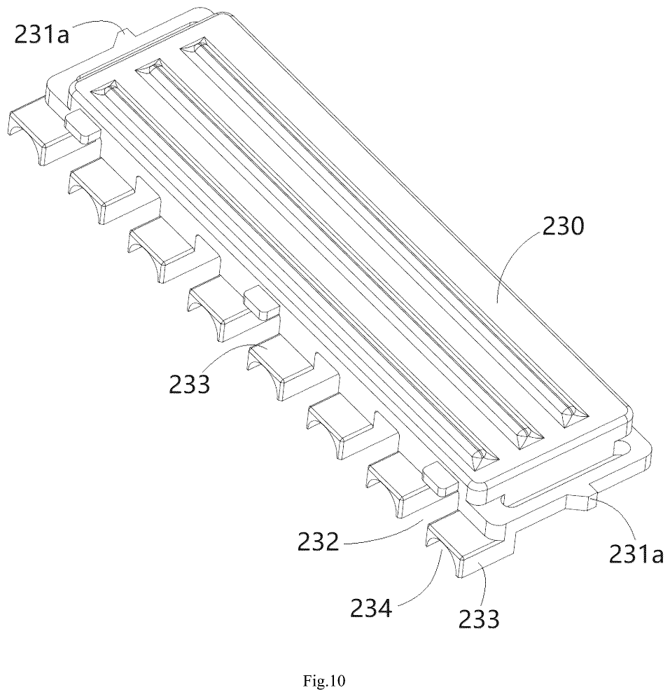

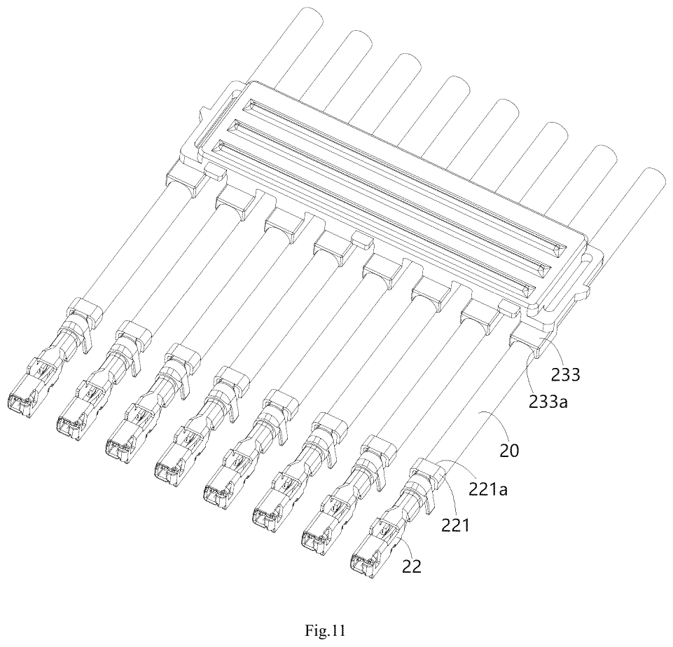

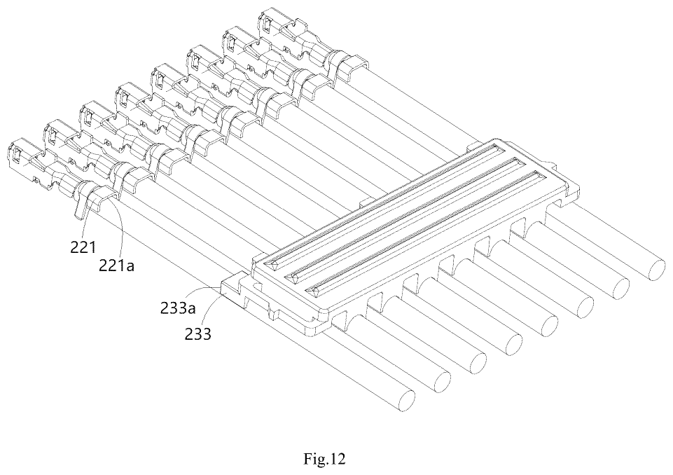

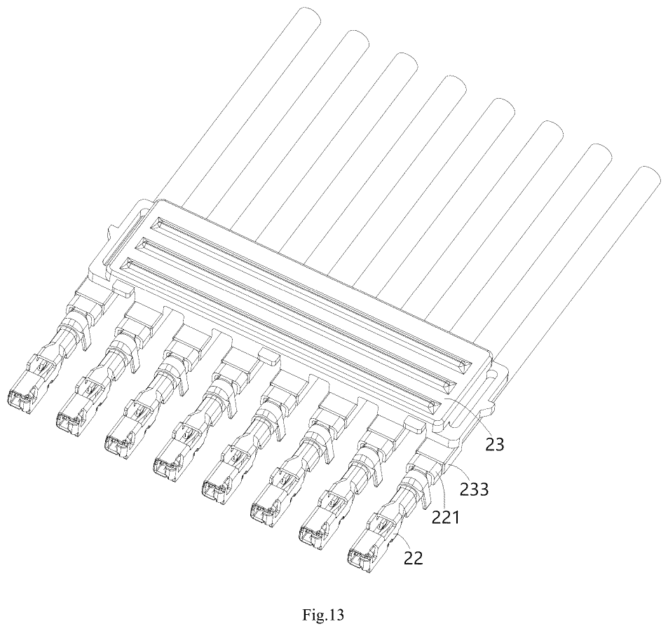

FIG. 8 shows an illustrative perspective view of the mating connector 2 according to an exemplary embodiment of the present invention when viewed from the bottom, wherein the terminal locking member 23 has been assembled onto the mating housing 21. FIG. 9 shows an illustrative perspective view of the mating connector 2 according to an exemplary embodiment of the present invention when viewed from the bottom, wherein the terminal locking member 23 has not yet been assembled onto the mating housing 21. FIG. 10 shows an illustrative perspective view of the terminal locking member 23 of the mating connector 2 according to an exemplary embodiment of the present invention. FIG. 11 shows an illustrative perspective view of the terminal locking member 23, terminal 22, and cable 20 of the mating connector 2 according to an exemplary embodiment of the present invention when viewed from the front side, wherein the terminal locking member 23 has not yet leaned against the terminal 22. FIG. 12 shows an illustrative perspective view of the terminal locking member 23, terminal 22, and cable 20 of the mating connector 2 according to an exemplary embodiment of the present invention when viewed from the rear, wherein the terminal locking member 23 has not yet leaned against the terminal 22. FIG. 13 shows an illustrative perspective view of the terminal locking member 23, terminal 22, and cable 20 of the mating connector according to an exemplary embodiment of the present invention when viewed from the front side, wherein the terminal locking member 23 has already leaned against the terminal 22;

As shown in FIGS. 1 to 13, in the illustrated embodiments, the mating connector 2 further includes a terminal locking member 23, which is installed on the mating housing 21 to lock the row of mating terminals 22 in the mating housing 21. An installation port 202 is formed on the bottom wall of the rear end of the mating housing 21, and the installation port 202 is communicated with the row of terminal holes 201. The terminal locking member 23 includes a main body 230 and a locking part 233. The main body 230 is plate-shaped and installed in the installation port 202 of the mating housing 21. The locking part 233 is connected to the main body 230 for pressing against the mating terminal 22 to lock the mating terminal 22 in the terminal hole 201.

The mating connector 2 further comprises a row of cables 20, which are respectively electrically connected to the row of mating terminals 22. In the illustrated embodiment, the mating terminal 22 is crimped onto the cable 20. The mating terminal 22 includes a U-shaped rear end portion 221, the rear end portion 221 of the mating terminal 22 is crimped on the cable 20, and the locking part 233 is pressed against the rear end face 221a of the rear end portion 221 of the mating terminal 22. A positioning groove 234 with a semi-circular cross-section is formed on the locking part 233, and the cable 20 is positioned in the positioning groove 234 of the locking part 233. The front end face 233a of the locking part 233 is pressed against the rear end face 221a of the rear end part 221 of the mating terminal 22.

Snap slots 203 are respectively formed on the inner sides of the left and right side walls of the rear end portion of the mating housing 21, and elastic arms 231 are respectively formed on the left and right sides of the main body 230 of the terminal locking member 23. A protrusion 231a is formed on the elastic arm 231, which is engaged with the snap slot 203 to lock the terminal locking member 23 to the mating housing 21.

A row of positioning insertion slots 232 is formed on the main body 230 of the terminal locking member 23, and the positioning insertion slot 232 is mated with a separating rib 212 between the adjacent two terminal holes 201. Multiple positioning tongues 235 are formed on the main body 230 of the terminal locking member 23, and the positioning tongues 235 are respectively inserted into the positioning slots 215 of the mating housing 21.

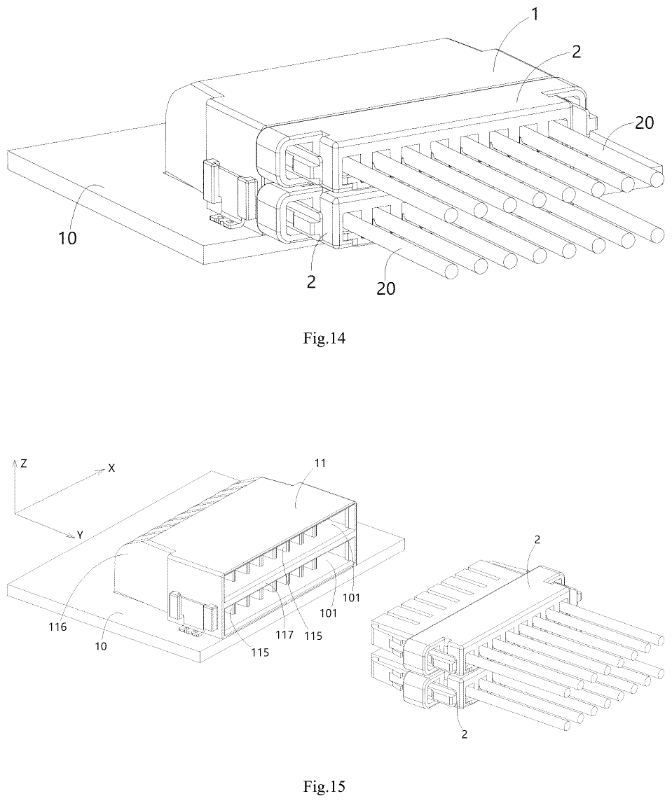

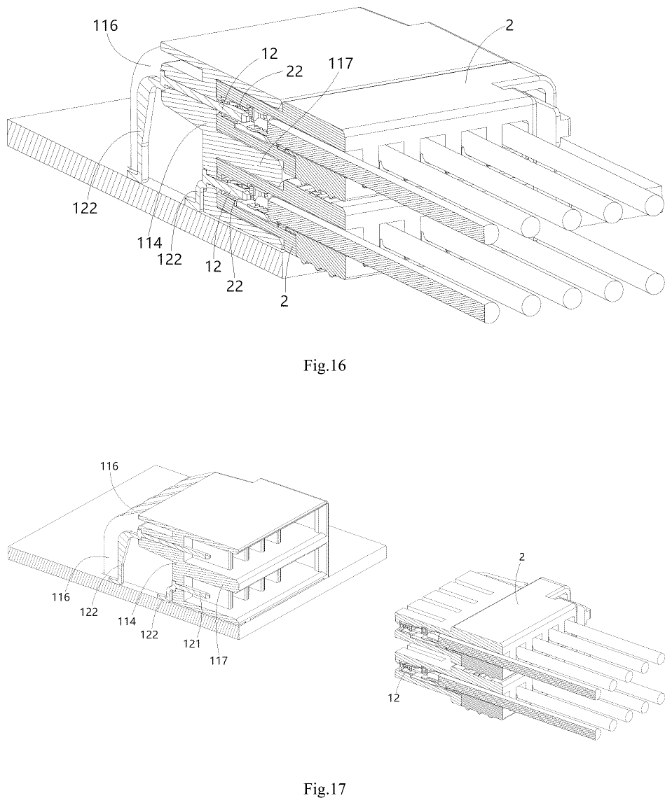

FIG. 14 shows an illustrative perspective view of a connector assembly according to another exemplary embodiment of the present invention. FIG. 15 shows an illustrative exploded view of a connector assembly according to another exemplary embodiment of the present invention. FIG. 16 shows a cross-sectional schematic diagram of a connector assembly according to another exemplary embodiment of the present invention, wherein the connector 1 and mating connector 2 have already been mated together. FIG. 17 shows a cross-sectional schematic diagram of a connector assembly according to another exemplary embodiment of the present invention, wherein the connector 1 and the mating connector 2 have not yet been mated together.

A main difference between the connector assemblies shown in FIGS. 14-17 and FIGS. 1-13 is the number of layers of inner chambers 101 of the housing 11 of connector 1. The other technical features of the connector assembly shown in FIGS. 14-17 are the same or similar to those shown in FIGS. 1-13, and can be referred to as the connector assembly shown in FIGS. 1-13.

Referring to FIGS. 14 to 17, in the illustrated embodiment, the housing 11 of connector 1 has multiple layers of inner chambers 101 arranged in the height direction Z and multiple rows of terminals 12 arranged in the height direction Z. The housing 11 includes a horizontal partition wall 117 that separates the adjacent two inner chambers 101, so that the mating parts 121 of the adjacent two rows of terminals 12 are separated by the horizontal partition wall 117.

The vertical partition wall 115 in the topmost inner chamber 101 of the multi-layer inner chamber 101 is connected between the top wall 111 of the housing 11 and the horizontal partition wall 117. The vertical partition wall 115 in the bottom layer of inner chamber 101 is connected between the bottom wall 112 of the housing 11 and the horizontal partition wall 117.

The housing 11 of the connector has multiple layers of inner chambers 101 adjacent to each other in the height direction Z and multiple rows of terminals 12 adjacent to each other in the height direction Z. The connector assembly includes multiple mating connectors 2. The mating connectors 2 are inserted into respective ones of the multiple layers of inner chambers 101 of the connector to mate with connector 1.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector, comprising:
a housing having at least one layer of inner chamber, each layer of inner chamber including multiple vertical partition walls formed therein and multiple vertical partition plates formed on an outer side of a side wall of the housing; and
at least one row of terminals respectively arranged in the at least one layer of inner chamber, each terminal including a mating part accommodated in the inner chamber for mating with a mating terminal of a mating connector and a connecting part extending from the side wall of the housing for electrically connecting to a circuit board, the mating parts of adjacent two terminals in each row of terminals are separated by the vertical partition wall, and the connecting parts of adjacent two terminals in each row of terminals are separated by the vertical partition plate.

2. The connector according to claim 1, wherein a leg is formed at the bottom of the vertical partition board and is adapted to be inserted into a slot in the circuit board.

3. The connector according to claim 2, wherein:
the housing comprises a top wall and a bottom wall opposite to each other in a height direction, two side walls opposite to each other in a transverse direction, and a rear opening and a front side wall opposite to each other in a longitudinal direction;
the multiple vertical partition walls are arranged in a row along the transverse direction, and the multiple vertical partition plates are arranged in a row along the transverse direction; and
the multiple vertical partition plates are connected to the outer side of the front side wall of the housing, and the connecting part of the terminal extends from the side wall of the housing.

4. The connector according to claim 3, wherein:
the connecting part of any terminal in each row of terminals is located between two adjacent vertical partition plates; and
a thickness of the two outermost vertical partition plates in a row of vertical partition plates is greater than that of the other vertical partition plates in the row of vertical partition plates.

5. The connector according to claim 3, wherein lock protrusions are respectively formed on inner sides of left and right side walls of each layer of inner chamber of the housing, the lock protrusions are adapted to engage with a mating housing of the mating connector to lock the mating housing inserted into the inner chamber of the housing in the inner chamber.

6. The connector according to claim 3, wherein the terminal further comprises a fixing portion located between the mating part and the connecting part and fixed to the front side wall of the housing.

7. The connector according to claim 3, further comprising a pair of welding legs installed on respective ones of the left and right side walls of the housing, wherein the pair of welding legs and the connecting part of the terminal are adapted to be soldered onto the circuit board in a surface mount manner.

8. The connector according to claim 1, wherein the housing has a single-layer of inner chamber, and the vertical partition wall is connected between the top wall and the bottom wall of the housing.

9. The connector according to claim 1, wherein the housing includes:
multiple layers of inner chambers arranged in the height direction and multiple rows of terminals arranged in the height direction; and
a horizontal partition wall that separates adjacent two layers of inner chambers, so that the mating parts of adjacent two rows of terminals are separated by the horizontal partition wall.

10. The connector according to claim 9, wherein:
the vertical partition wall in the topmost layer of inner chamber is connected between the top wall of the housing and the horizontal partition wall; and
the vertical partition wall in the bottommost layer of inner chamber is connected between the bottom wall of the housing and the horizontal partition wall.

11. The connector according to claim 1, wherein the connector is a high-voltage connector suitable for voltages above 1000V, and the pitch between adjacent terminals in each row of terminals is not greater than 3.5 mm.

12. A connector module, comprising:
a circuit board; and
a connector installed on the circuit board, including:
a housing having at least one layer of inner chamber, each layer of inner chamber including multiple vertical partition walls formed therein and multiple vertical partition plates formed on an outer side of a side wall of the housing; and
at least one row of terminals respectively arranged in the at least one layer of inner chamber, each terminal including a mating part accommodated in the inner chamber for mating with a mating terminal of a mating connector and a connecting part extending from the side wall of the housing and electrically connect to the circuit board, the mating parts of adjacent two terminals in each row of terminals are separated by the vertical partition wall, and the connecting parts of adjacent two terminals in each row of terminals are separated by the vertical partition plate.

13. The connector module according to claim 12, wherein a row of slots are formed in the circuit board, and the legs of the row of vertical partition plates of the housing of the connector are respectively inserted into the row of slots.

14. A connector assembly, comprising:
a connector, including:
a housing having at least one layer of inner chamber, each layer of inner chamber including multiple vertical partition walls formed therein and multiple vertical partition plates formed on an outer side of a side wall of the housing; and
at least one row of terminals respectively arranged in the at least one layer of inner chamber, each terminal including a mating part accommodated in the inner chamber for mating with a mating terminal of a mating connector and a connecting part extending from the side wall of the housing for electrically connecting to a circuit board, the mating parts of adjacent two terminals in each row of terminals are separated by the vertical partition wall, and the connecting parts of adjacent two terminals in each row of terminals are separated by the vertical partition plate; and
a mating connector inserted into the inner chamber of the housing of the connector and mating with the connector.

15. The connector assembly according to claim 14, wherein the mating connector comprises:
a mating housing adapted to mate with the housing of the connector and formed with a row of terminal holes, the mating housing having a front end portion inserted into the inner chamber of the housing; and
a row of mating terminals inserted into the row of terminal holes of the mating housing, the mating part of the terminal of the connector is mated with the mating terminal inserted into the inner chamber.

16. The connector assembly according to claim 15, wherein a row of partition slots is formed in the front end portion of the mating housing, and the row of vertical partition walls in the inner chamber of the housing are inserted into the row of partition slots of the mating housing.

17. The connector assembly according to claim 15, wherein elastic buckles are formed on outer sides of left and right sides of the front end portion of the mating housing, the elastic buckle engages with locking protrusion in the inner chamber of the housing to lock the connector and the mating connector together.

18. The connector assembly according to claim 17, wherein the elastic buckle includes:
a cantilever part having an end connected to the mating housing; and
a protruding part formed on the cantilever part, the protruding part on the elastic buckle engaging with the locking protrusion in the inner chamber of the housing.

19. The connector assembly according to claim 15, wherein:
the mating connector further includes a terminal locking member installed on the mating housing and adapted to lock the row of mating terminals in the mating housing;
an installation port is formed on the bottom wall of the rear end of the mating housing, and the installation port is communicated with the row of terminal holes; and
the terminal locking member includes:
a plate-shaped main body installed in the installation port of the mating housing; and
a locking part connected to the main body and adapted to press against the mating terminal to lock the mating terminal in the terminal hole.

20. The connector assembly according to claim 14, wherein:
the housing of the connector has multiple layers of inner chambers arranged in a height direction and multiple rows of terminals arranged in the height direction; and
the connector assembly includes multiple mating connectors inserted into the multiple layers of inner chambers of the connector to mate with the connector.
